(19) United States
(12) Patent Application Publication
(10) Pub. No.: US 2006/0136722 A1
(43) Pub. Date: Jun. 22, 2006

(54) Secure communication system and communication route selecting device

(75) Inventors: Takao Ogura, Kawasaki (JP); Kohei Iseda, Kawasaki (JP); Hirobumi Suzuki, Kawasaki (JP)

Correspondence Address: SWIDLER BERLIN LLP, 3000 K STREET, NW, BOX IP, WASHINGTON, DC, 20007, US

(73) Assignee: FUJITSU LIMITED

(21) Appl. No.: 11/105,434

(22) Filed: Apr. 14, 2005

(30) Foreign Application Priority Data
Dec. 22, 2004 (JP) 2004-372124

(51) Int. Cl. H04L 9/00; G06F 12/14; H04L 9/32; G06F 11/00; G06F 11/30; G06F 11/22; G06F 11/32; G06F 11/34; G06F 11/36; G06F 12/16; G06F 15/18; G08B 23/00

(52) U.S. Cl. 713/168; 713/188; 726/24

(57) ABSTRACT

A communication system for realizing a secure communication comprises a selecting device for making a selection between a communication route for a direct communication with a communication partner side and a communication route via a security checking device for checking security of communication, in accordance with a communication partner or an application corresponding to the communication. Also, the communication system comprises a device for marking a communication packet for route selection in order that the selecting device conducts a route selection in accordance with contents of the marking.

### BACKGROUND OF THE INVENTION

1. Field of the Invention

The present invention relates to a method of securing security in a communication network, and more particularly to a secure communication system and a communication route selecting device by which a selection is made, in accordance with a communication partner or an application corresponding to the communication, between a communication route for a direct communication with a communication partner and a communication route via a security center such as, for example, a virus check center or the like in order that the security of communication is secured without causing the bias in traffic.

2. Description of the Related Art

The threat against the security of information such as computer viruses, worms and the like has increased with respect to the extended use of a network such as the Internet and the like. In order to cope with such a threat against security, new services have started conducting communications of data via a security check center.

FIG. 1 explains a communication method in a conventional secure communication system which conducts the virus check as above. In FIG. 1, all of communication data transmitted via the internet, for example, between user terminals or between a server providing a particular service and a user terminal, is transmitted to communication partner side via a virus check center, being virus checked.

However, when a virus check as a security service is conducted for all communications e.g. for all packets, as above, a load on a server in the virus check center is increased, the communication throughput is reduced, and the traffic is concentrated to the peripheral communication links of the virus check center so there is a possibility of the bias in traffic. Therefore, there has been a problem that the communication method as above is difficult to be used for a large scale network used by many users.

Specifically, the route control such as to select a direct communication with the partner side not via a virus check center for a particular communication partner, for example, has been difficult because, in a conventional communication system, a broad band router of a user side and a virus check center, for example, are directly connected to each other on virtual private network (VPN) or the like by point-to point tunneling protocol (PPTP).

The documents below disclose conventional techniques for securing the security or for enhancing communication qualities in the above communication system.

[Patent Document 1]

Japanese Patent No. 3173505 “Packet communication system”

[Patent Document 2]

Japanese Patent Application Publication No. 2001-358771 “Communication quality controlling device”

[Patent Document 3]

Japanese Patent Application Publication No. 2003-204348 “Storage device supporting virtual LAN”

Japanese Patent No. 3173505 discloses a technique in which a monitoring device for detecting a transmission congestion of many packets in a short time period to meet the situation that the amount of incoming packets overflows a capacity of a packet communication system in order that a stably operating packet communication system is provided.[c1]

Japanese Patent Application Publication No. 2001-358771 discloses a communication quality controlling device for determining the transmission destination in accordance with the data of the protocol layer “3” or of the lower-numbered layer included in the received datagram and also for determining communication qualities for transmitting the data in accordance with the communication attribute information extracted from the layer information of protocol layers from “4” to “7”.

Japanese Patent Application Publication No. 2003-204348 discloses a secure IP protocol storage device utilizing a technique of virtual local area network as a technique for enhancing security of a storage device connected to IP network.

However, the techniques disclosed in the above three documents have not succeeded in solving the problem in a communication network to which the present invention addresses i.e. the problem that load on a server of a virus check center is increased when all the communication data is transmitted via the virus check center or the like.

### SUMMARY OF THE INVENTION

In the light of the above problem, it is an object of the present invention to avoid the increase of the load on a server, the reduction of throughput and bias in communication traffic in a security center while securing the security of communication, by permitting a selection, in accordance with a communication partner side or an application corresponding to the communication, between a communication route for a direct communication with a communication partner side and a communication route via a security center, instead of conducting a communication of all data via a security center such as a virus check center. A communication system according to the present invention is for realizing a secure communication and comprises a communication route selecting device for making a selection between a communication route for a direct communication with a communication partner side and a communication route via a security checking device for checking security of communication, in accordance with a communication partner and/or an application corresponding to the communication.

A communication route selecting device according to the present invention is for making a selection of a communication route to a communication partner side, and makes a selection between a communication route for a direct communication with a communication partner side and a communication route via a device for checking security of communication in accordance with a communication partner and/or an application corresponding to the communication.

### BRIEF DESCRIPTION OF THE DRAWINGS

FIG. 1 explains an example of a conventional method of virus check for realizing a secure communication;

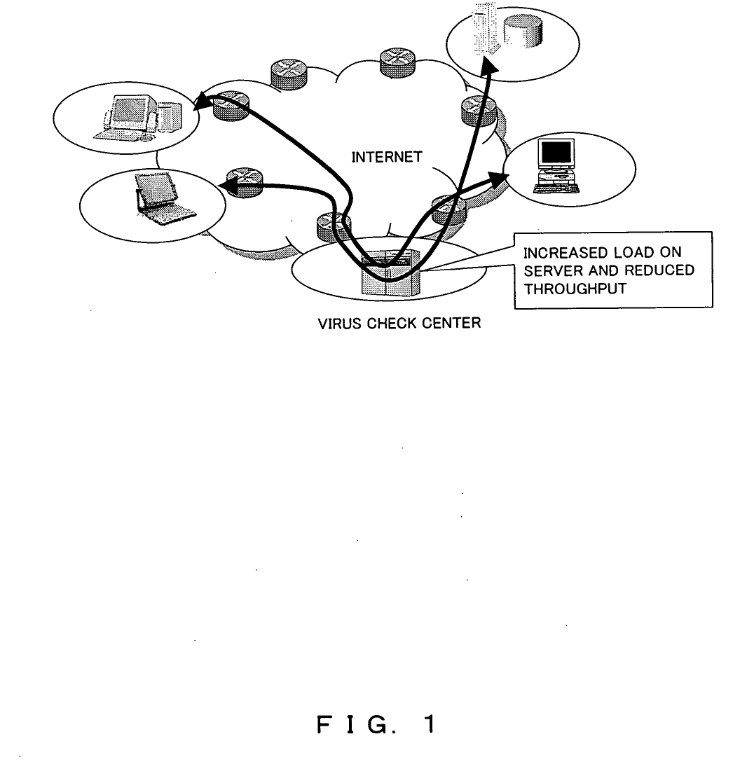

FIG. 2 is a block diagram for showing a principle configuration of a secure communication system according to the present invention;

FIG. 3 shows an example of a configuration of a communication system in which a method of selecting a communication route according to the present invention is used;

FIG. 4 explains a security check process in case that a packet is transmitted via two networks (domains);

FIG. 5 explains a communication method in case that a virus check is conducted by an Internet service provider;

FIG. 6 explains a communication method in case that the virus check is conducted in a router in a communication network;

FIG. 7 explains storage of marking information in TOS field of IP header;

FIG. 8 shows a format of a packet when a dedicated header for security is defined;

FIG. 9 is a block diagram for showing a configuration example including a marking device, a route selecting device and a managing device;

FIG. 10 is a flowchart of a marking information setting process by a marking device;

FIG. 11 is a flowchart of the whole of a marking process by the marking device;

FIG. 12 is a first detailed flowchart of the marking process;

FIG. 13 is a second detailed flowchart of the marking process;

FIG. 14 is a third detailed flowchart of the marking process;

FIG. 15 is a flowchart of a security center information setting process by a route selecting device;

FIG. 16 is a detailed flowchart of a packet output route selecting process by the route selecting device;

FIG. 17 is a flowchart of a marking information setting process on a marking device by a managing device;

FIG. 18 is a flowchart of a process by a virus checking device;

FIG. 19 explains a method of encoding marking information between the marking device and the route selecting device;

FIG. 20 is a block diagram of a configuration example of LSI dedicated for marking; and

FIG. 21 is a block diagram of a configuration example of the LSI dedicated for the route selection.

### DESCRIPTION OF THE PREFERRED EMBODIMENTS

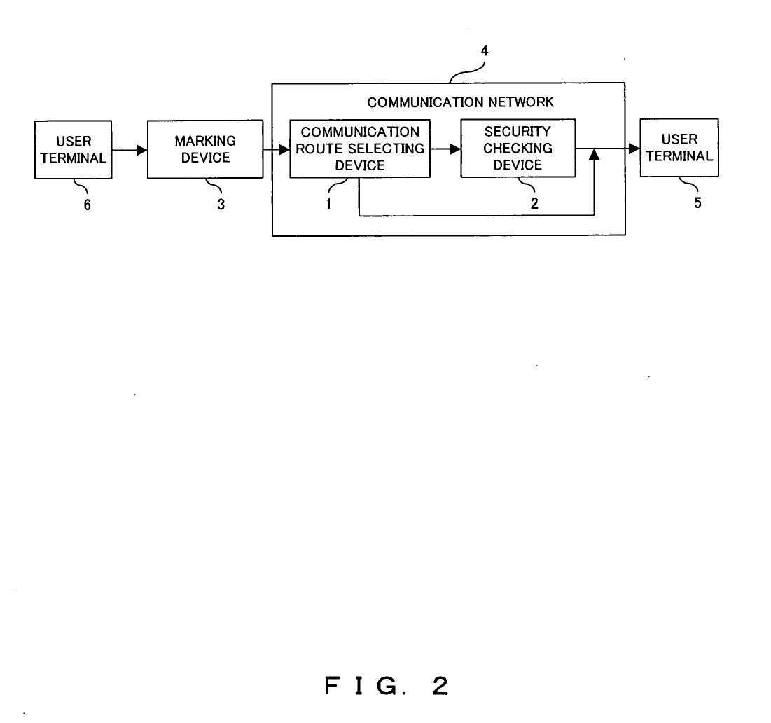

FIG. 2 is a block diagram for showing a principle configuration of a secure communication system according to the present invention. In FIG. 2, the secure communication system comprises a route selecting device 1 for making a selection, in accordance with a communication partner and/or an application corresponding to the communication, between a direct communication route with a communication partner side such as, for example, a user terminal 5, and a communication route via a security checking device 2 for checking security of communication.

According to an embodiment of the present invention, the communication system may be a packet communication system which further comprises a marking device 3 for marking the communication packet for security in accordance with a communication partner and/or an application corresponding to the communication so that the route selecting device 1 selects the route in accordance with the content of the marking.

According to an embodiment of the present invention, a configuration is possible so that the marking device 3 further adds, to communication data e.g. a header of a packet, level information for specifying the level of security check so that the security checking device 2 conducts a security check of the specified level. Further, according to the embodiment of the present invention, when a plurality of the security checking devices 2 exist on the communication route selected by the route selecting device 1, the communication packet transmitted from the transmitting side of the communication data (e.g. a user terminal 6), to which packet the level information is added by the marking device 3, is security checked by the security checking device 2 which has firstly received the communication packet on the communication network 4 from the route selecting device 1, thereafter, the level information is rewritten into a level specifying that a security check is not needed in order that the packet is output on a further selected communication route.

According to an embodiment of the present invention, the marking device 3 can store the marking data specifying a selected route and/or a security check level in header information of a packet. In this case, the marking data can be set in a field of type of service in the header information of IP packet, or can be set in a storage area of reserved bits in the authentication header in IP security protocol communication, or further, can be set in a dedicated header storage area by creating the dedicated header in a storage area originally for communication data in IP packet, for example.

According to an embodiment of the present invention, the marking device 3 can be arranged in a network to which the user terminal 6 is connected such as a local area network for example, instead of being arranged in a network 4 in which the route selection is made, or the user terminal 6 can also have a function of the marking device 3. In this case, the route selecting device 1 can be arranged at the entrance of a network 4, for example, the route being selected in the network, and the marking device 3 can further comprise an encoding unit for encoding the marking information. Also, the marking device 3 can be arranged at the entrance of the network 4.

According to an embodiment of the preset invention, the marking device 3 can further comprise a policy rule storing unit for storing a policy rule for marking which is received from a service provider upon a contract regarding an application corresponding to the communication, between the service provider and the transmitting side of the communication in order that the marking is conducted in accordance with the policy rule at a time of starting communication corresponding to the application.

Also, in case that the transmitting side of communication communicates with a communication partner side via an intermediary, the user terminal 6 which also has a function of the marking device 3 can receive the policy rule for marking from the intermediary in order to mark the packet.

Also, the marking device 3 can conduct the above marking, together with setting of the header information in Diff-Serv which is a technique for the quality of service control for IP packet as communication packet, i.e. setting both of data for Diff-Serv and marking data in the header.

Further, in an embodiment of the present invention, the security checking device 2 can be arranged in a router of the network 4 in a communication system. Or the security checking device 2 can be arranged in a network other than the network 4 in which the communication route is selected such that the communication route is constituted of a route from the transmitting side to the security checking device and a route from the security checking device to the communication partner side.

Next, the communication route selecting device according to the present invention selects a communication route to the communication partner side for realizing a secure communication, in which a selection is made, in accordance with a communication partner and/or an application corresponding to the communication, between a communication route for a direct communication with a communication partner side and a communication route via a device for checking the security of the communication.

According to an embodiment of the present invention, the method of the communication is a packet communication and the selection of the communication route can be made by the communication route selecting device in accordance with header information or information including a port number of the transmitting side in a transmission packet.

As above, according to the present invention, header information of a packet, for example, is input to the route selecting device, and the header information is marked with data specifying which route is to be selected between a direct communication route with a communication partner side and a communication route via a security checking device so that the communication route for transmission of the packet is selected based on the marked header information.

According to the present invention, it is possible that the selection of communication route is made between a communication route via a security center and a direct communication route with a partner side so that the decrease of load on a security center and the avoidance of the bias in communication traffic are realized. Therefore, the above configuration can greatly contribute to the reduction of server cost of a security center and the efficient utilization of work resource of a network.

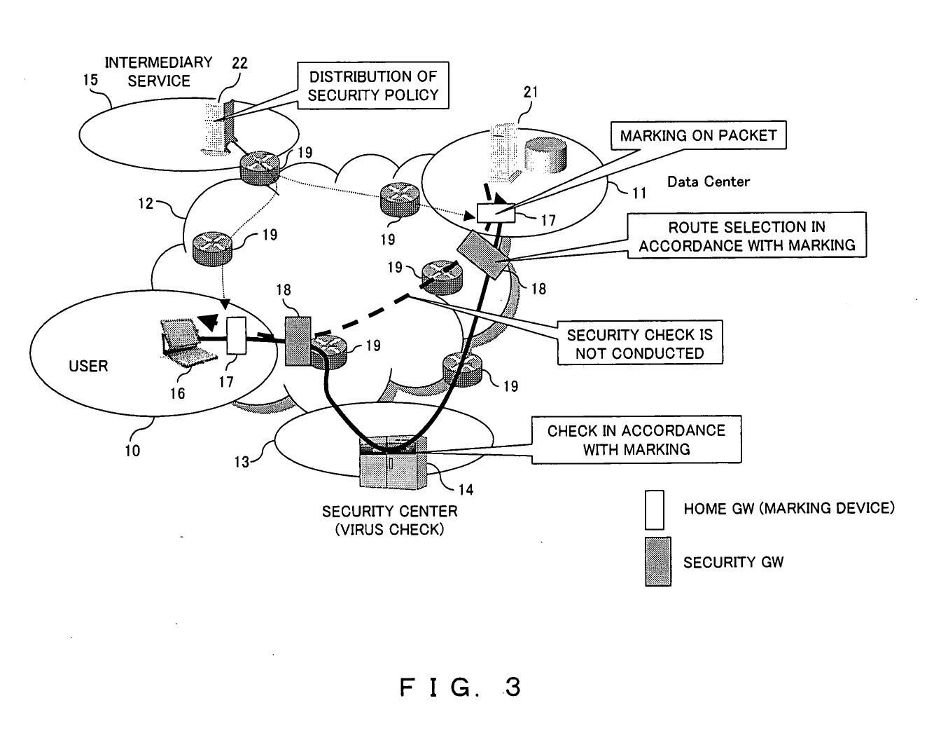

FIG. 3 shows an example of a configuration of a packet communication system in which a method of selecting a communication route according to the present invention is used. In FIG. 3, it is assumed that, for example, a packet communication is conducted between a user 10 and a data center 11, and a packet transmitted from the user 10 to the data center 11 is transmitted via a security center 13 so that the packet is transmitted to the data center 11 after being virus checked by a virus checking device 14. Also, it is assumed that a packet transmitted from the data center 11 to the user 10 is directly transmitted to the user 10 side not via the security center 13.

As for a communication between the user 10 and the data center 11 being basically conducted via a network service provider (NSP) i.e. via a network 12 of the carrier, it is assumed that a security policy for the route selection in the above communication is transmitted, for example, from a managing device 22 provided in, for example, a service provider 15 for providing an intermediary service to a home gateway 17 as a marking device to which a terminal 16 of the user 10 side so that a packet is marked. However, the managing device for distributing a security policy such as above can be provided in the NSP side instead of the intermediary service side 15.

A user makes a contract with a service provider for providing intermediary services to be provided with various services such as e-mail, streaming and the like, and upon such a contract, a security policy in accordance with the service i.e. the application is set in the home gateway 17 as a marking device, being transmitted from the intermediary service 15 side via a router 19 in the network 12.

In FIG. 3, when a user accesses the data center 11 on the enterprise network side, a communication based on file transfer protocol (FTP) is conducted from the user 10 to the data center 11 via the marking device 17, a security gateway 18, a router 19 and the virus checking device 14 in the security center 13. When data is uploaded from the data center 11, a server 21 of the data center 11 side and the user terminal 16 of the user side 10 are connected to each other with a direct transmission route via the home gateway 17, the security gateway 18 and the router 19.

For example, a security policy set in the home gateway 17 as the marking device of the user 10 side is constituted of condition and action. The condition includes, for example, a transmission/reception IP address, a protocol ID, a port number and the like of IP header and the action includes contents to be set as the marking information. The information of the marking as the action includes, for example, information for route selection (route flag) and information for security check level. The route flag of “0” specifies the direct route and the route flag of “1” specifies the route via a security center while the check level of “0” specifies that check is not needed and the check levels of “1”, “2” and “3” respectively specify the levels of 1, 2 and 3 on which the check is to be conducted.

The example of the marking information set in the home gateway 17 in the user 10 side is shown below.

IF; IP-S_addr:ww.xx.yy.zz, Port:21 (FTP)

Then; routeFlag:1, checkLevel:2

In the above information, the address of the transmitting source “S” i.e. the address of the terminal 16 of the user side and the port number are specified in order that the type of the service to which the communication corresponds is identified and the route flag and the check level are set based on the identified type of the service.

The example of the information set in the home gateway 17 of the data center side is shown below.

IF; IP-S_addr:ww.xx.yy.zz, IP-D_addr:aa.bb.cc.dd

Then; routeFlag:0

In the above information, the address of the transmitting source “S” is the address of the server 21 of the data center 11 side, and the address of the destination “D” specifies the address of the terminal 16 of the user to which the data is uploaded. The route flag specifies the direct route not via the security center 13.

The home gateway 17 as the marking device in the user 10 side finds the IP packet that matches the set condition in accordance with the information of header added to an IP packet (transmission/reception IP address and protocol ID) and a port number and the like, and the home gateway 17 marks the making area (described later) with the information for the route flag and the security check level in order to transmit the marked IP packet to the network 12 side.

The security gateway 18 having a function of the route selecting device makes a route selection based on the marking information added to the input IP packet. When the value of the route flag is “0”, a direct communication route is selected and when the value of the route flag is “1”, a route via a security center to a communication partner side is selected. Also, it is possible that the security gateway 18 provided in the entrance of the network 12 makes a route selection based on the information of the header of the IP packet without marking the packet.

The virus checking device 14 of the security center 13 conducts a virus check process in accordance with the information of the check level. For example, when the check level is “0” fore-mail, no process is conducted, when the check level is “1”, only the title, the text and the name of attached file are checked, when the check level is “2”, data matching i.e. the matching with the data of virus in case that the data of virus is identified is conducted in addition to the checks on the title, the text and the name of attached file, when the check level is “3”, a simulation of an attached file is conducted when the attached file is an executable file in addition to the checks on the title, the text and the name of attached file.

The marking device of the communication partner side i.e. the home gateway 17 deletes the marking information added to the header of the received IP packet in order to output the packet to the server 21 in the data center 11, for example.

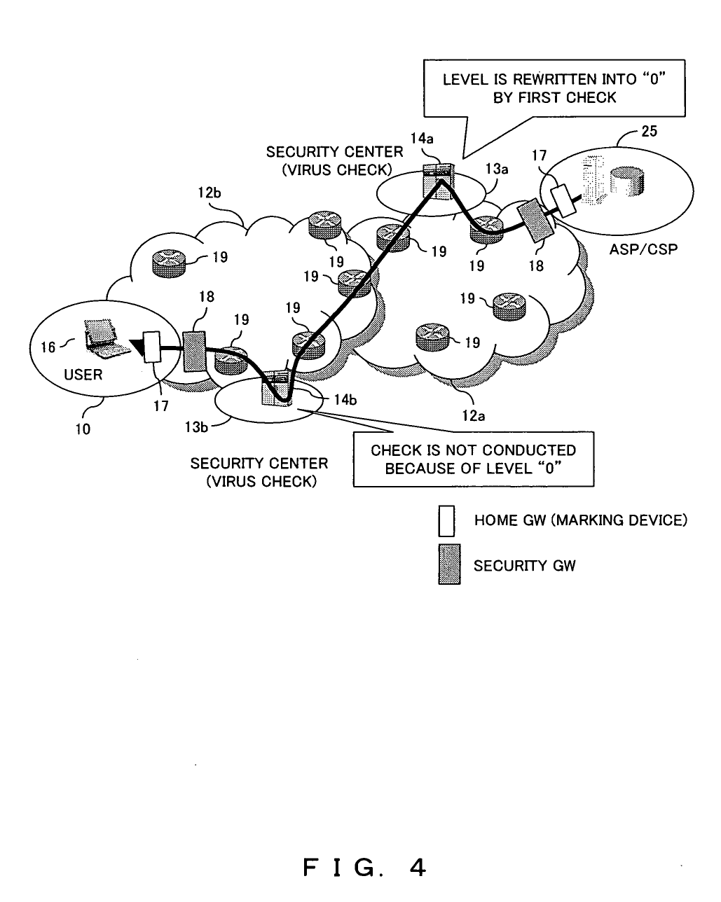

FIG. 4 explains a security check process for a communication via two networks. When data is transmitted from, for example, an application service provider (ASP) or a contents service provider (CSP) 25 to the user 10 side via, for example, two networks respectively corresponding to different carriers or two domains 12ₐ and 12_{b}, a marking is conducted on a packet in the home gateway 17 of the ASP/CSP 25 side and a route via a security center 13a is selected by the security gateway 18 so that the data is virus checked by a virus checking device 14ₐ provided in correspondence with NSP of the network 12ₐ. Thereafter, the security check level information is rewritten into “0” specifying that a check is not needed by this virus checking device 14ₐ and the data is transmitted to the network side 12_{b} side. In the virus checking device 14_{b} provided in the NSP corresponding to the network 12_{b}, a security check is not conducted because the security check level information added to the received packet is “0”, and the packet is output to the terminal 16 of the user.

In the above configuration, the virus check process is conducted by the first virus checking device 14ₐ, and when the check result is “OK”, the check level is rewritten into “0” so that the subsequent process of packet transmission is conducted with the check level “0”. This is because it is basically assumed that infection by virus occurs in a terminal of user side, a local area network or the like for example, and does not occur in the network of a carrier for example. When the packet is transmitted in an encoded state in the network of a carrier in order to further enhance the security, for example, the infection by the virus is avoided.

When infection of a packet by virus is detected in a virus check center, the packet is canceled or the virus is quarantined. In the quarantine of virus, the data of virus itself is removed from the packet, and the data before the infection by virus is not always restored, however, by the quarantine, the influence of the virus i.e. the subsequent infection to other data can be avoided at least. Also, the infection by virus is notified to the transmitting source of the packet by e-mail or the like, as occasion demands.

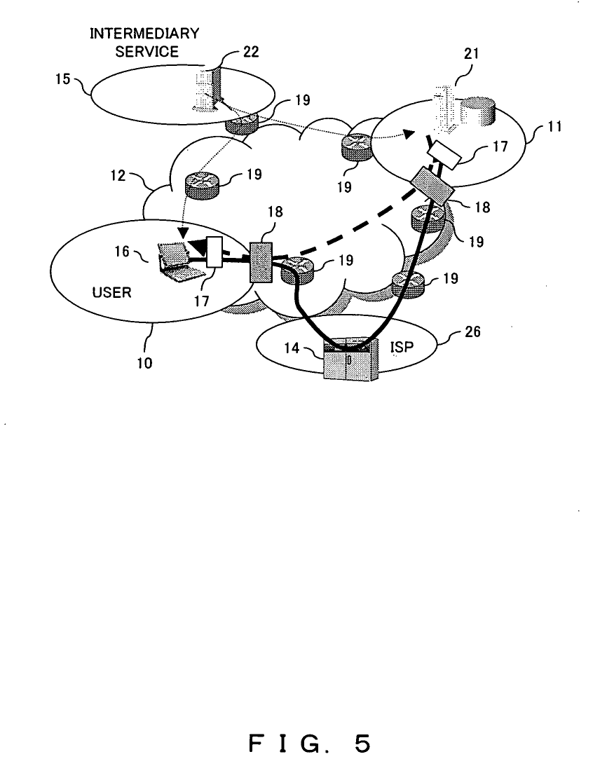

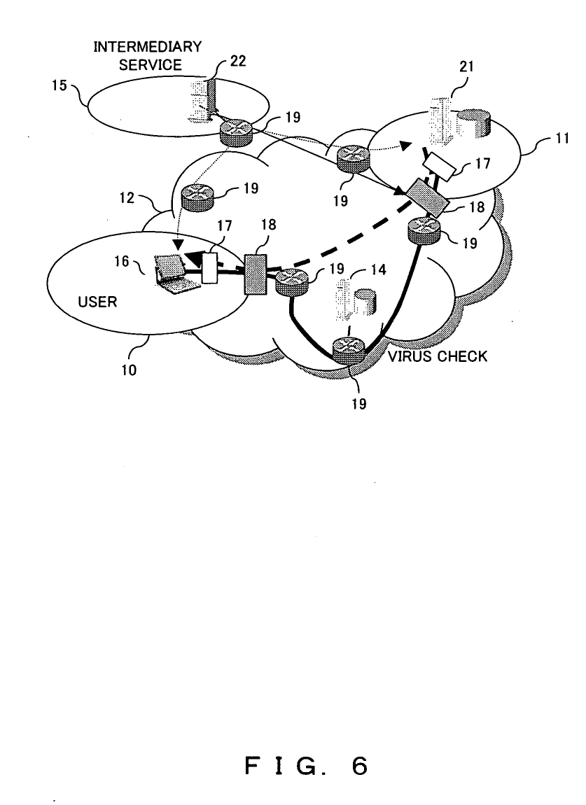

FIG. 5 and FIG. 6 explain a way of arranging virus check function in the communication system. In FIG. 5, the virus checking device 14 is arranged in an Internet service provider (ISP) 26 side. In this case, because the virus checking device 14 is separated from the communication network 12 of the NSP side as a carrier for example, there are two communication routes i.e. a communication route between a communication source such as the user 10 for example and the virus checking device 14, and a communication route between the virus checking device 14 and the communication partner side such as the data center 11 for example. In the above case, the ISP 26 serves also as an intermediary of the communication so that the ISP 26 can set the previously described security policy in the home gateway 17 of the user 10 side or the terminal 16 of the user.

FIG. 6 shows a case that the virus checking device 14 is arranged in the router 19 in the communication network 12 of a carrier for example. In this case, the NSP corresponding to the network 12 provides the virus check function so that a communication between a communication source and a communication partner side can be conducted with just one communication route.

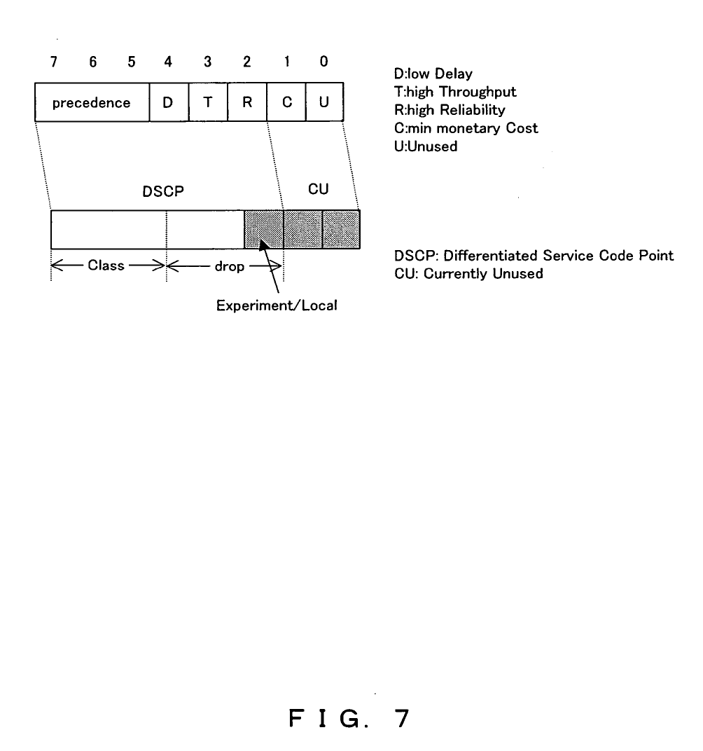

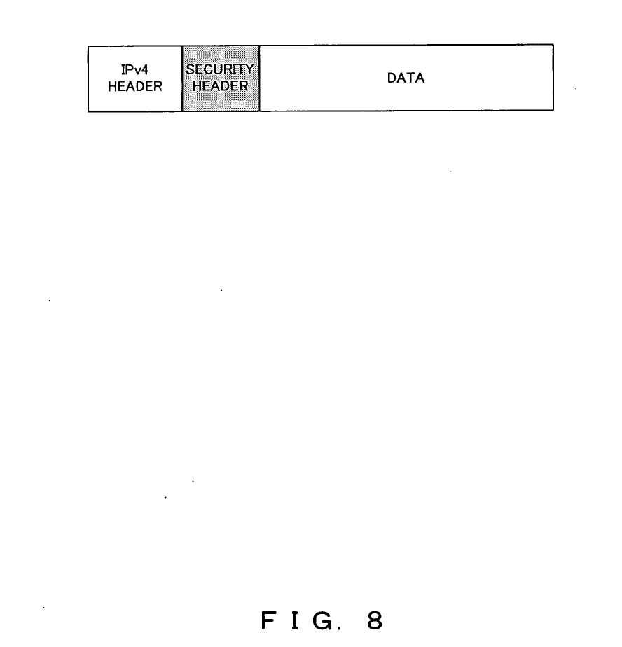

Next, explanation is given regarding the addition of the marking information to the packet by using FIG. 7 and FIG. 8. FIG. 7 explains the way of storing the marking information in TOS field of the IP header. There is a field of eight bits length for storing type of service (TOS) information as the third element in the header information of IP packet. In the TOS field, for example, the data of precedence for specifying the priority in the packet transmission process by six stages is stored in the first to third bits.

The above eight bits field is used for DSCP (Differentiated Service Code Point) of six bits in the technique of Diff-Serv as a technique for the QoS control (Quality of Service control) for the IP. The information in these six bits is stored in the first six bits of the eight bits corresponding to TOS field. In these six bits, data specifying a class of service and data specifying a drop as the drop probability of packet are stored. And the last or the sixth bit i.e. experimental/local bit which is not used is allocated for the route flag and the remaining two bits i.e. currently unused (CU) bits are allocated for the check level. Specifically, “00” of these two bits specifies that the check is not needed, “01” of the two bits specifies level 1, “10” of the two bits specifies level 2 and “11” of the two bits specifies level 3.

As above, according to an embodiment of the present invention, unused bits in the Diff-Serv are used for the marking in order that the quality of service control by the Diff-Serv and the route selection by the marking can be conducted together.

FIG. 8 shows a format of a packet when a security header for marking is defined dedicatedly. The security header as the dedicated header is defined next to the usual IPv4 header, so that the information of route flag and the check level is stored in the header. The area is originally for storing data, therefore, in the above configuration, the security header is defined dedicatedly in the data storing area.

As for a way of marking a packet, there is a way which uses AH header in Ipsec communication, in addition to the ways explained by FIG. 7 and FIG. 8. The IPsec communication is a method in which functions of authentication and encoding are added to TCP/IP communication and in this method, a header called authentication header (AH) is added to IP packet in order to be used for the authentication regarding the transmission source. And in the AH header, there are two bytes of reserved bits which are currently unused, therefore, the data of the route flag and the check level can be stored by using the reserved bits.

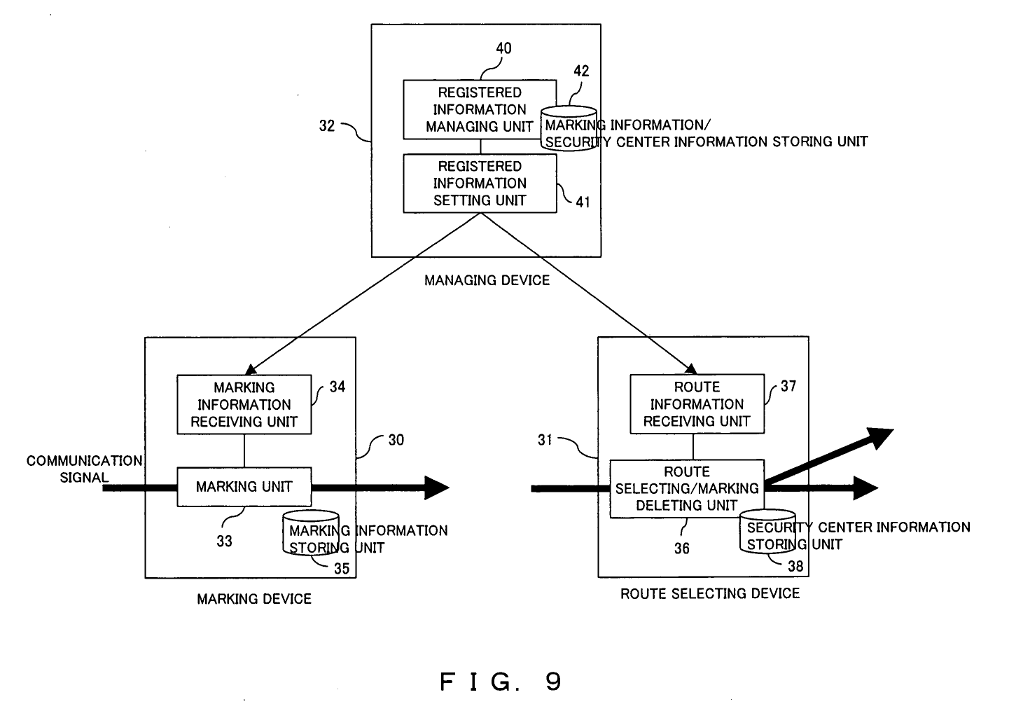

FIG. 9 is a block diagram for showing a configuration example including a marking device, a route selecting device and a managing device respectively corresponding to the home gateway 17, the security gateway 18 and the server 22 for distributing a security policy, for example, on the intermediary service 15 side, which are explained in FIG. 3. In FIG. 9, the managing device 32 is connected to the marking device 30 and the route selecting device 31, and data corresponding to a security policy is distributed to the marking device 30 and the route selecting device 31. As a matter of course, the managing device 32 can be provided in the network service provider (NSP) side which manages the network 12 instead of in the intermediary service 15 side.

In FIG. 9, the marking device 30 comprises a marking unit 33 for making a packet, a marking information receiving unit 34 for receiving marking information as a security policy given from the managing device 32 and a marking information storing unit 35 for storing the received marking information.

The route selecting device 31 comprises a route selecting/marking deleting unit 36 for selecting a route at the entrance side of network and for deleting marking information added to a packet at the exit side of network, a route information receiving unit 37 for receiving, from the managing device 32, route information specifying a route via a security center in accordance with a security policy, and a security center information storing unit 38 for storing the received route information.

The managing device 32 comprises a registered information managing unit 40 for managing a security policy and the like as registered information, a registered information setting unit 41 for transmitting the security policy and security center information to the marking device 30 and the route selecting device 31 side, and a storing unit 42 for storing the marking information and the security center information as the registered information.

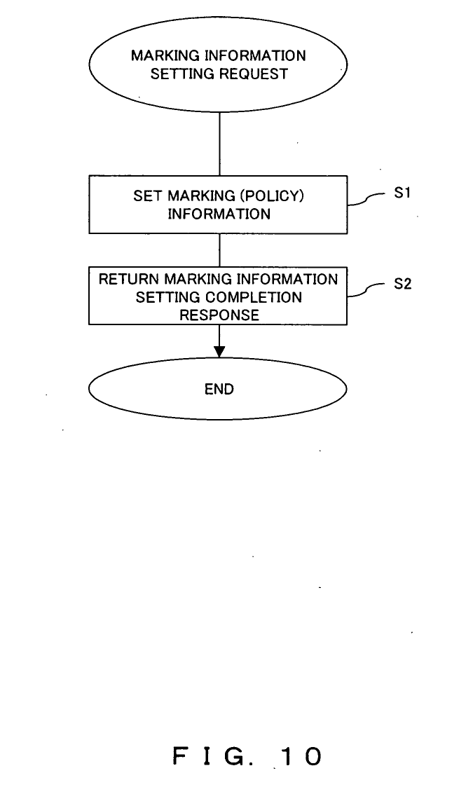

Next, processes by the marking device 30, the route selecting device 31, the managing device 32 of FIG. 9 and the virus checking device are explained by using flowcharts of FIG. 10 to FIG. 18. FIG. 10 is a flowchart of a marking information setting process by the marking device. When a marking information setting request as the registered information is transmitted from the managing device 32 to the marking device 30 in FIG. 9, in step S1, security policy information as the marking information is set i.e. the information is stored in the marking information storing unit 35, and in step S2, a marking information setting completion response is returned to the managing device 32 so that the process is ended.

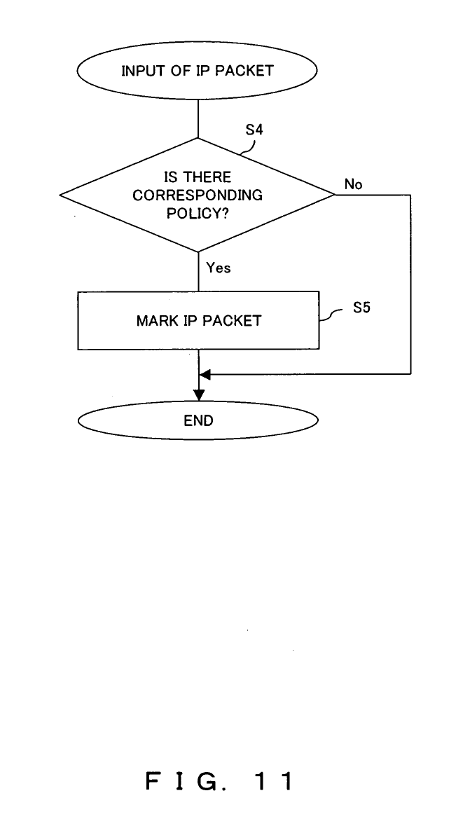

FIG. 11 is a flowchart of a marking process conducted on an IP packet by the marking device 30. When an IP packet is input from, for example, a user terminal side, it is determined whether or not a security policy for an application or the like corresponding to the transmission packet by using the information and the like in a header of the packet in step S4 so that marking is conducted on the header information of the IP packet in step S35 when the security policy exists and when the security policy does not exist, the process is immediately ended and the packet is output.

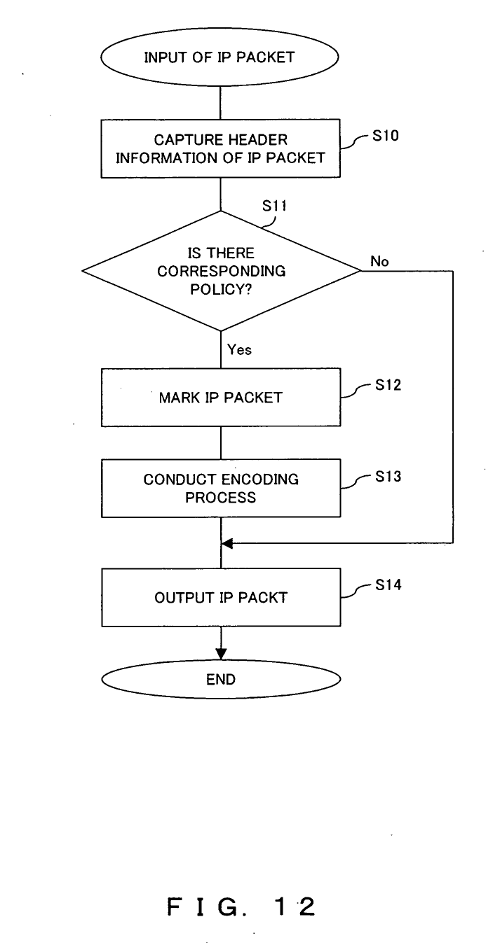

FIG. 12 to FIG. 14 are detailed flowcharts of the above marking process on the packet. There are three ways for marking packet as explained in FIG. 7 and FIG. 8. And the above three flowcharts respectively correspond to the three ways of marking.

FIG. 12 is a detailed flowchart corresponding to a way of storing marking information which uses TOS field explained in FIG. 7. When an IP packet is input, header information of the IP packet is captured i.e. read out in step S10 and it is determined whether or not a policy for a service corresponding to the packet exists. When the policy exists, marking is conducted on the packet in step S12 and an encoding process is conducted in order to secure the security, for example, between the marking device 30 and the route selecting device 31 as will be described later, and when the policy for a service does not exist the IP packet is output in step S14 in order to end the process immediately.

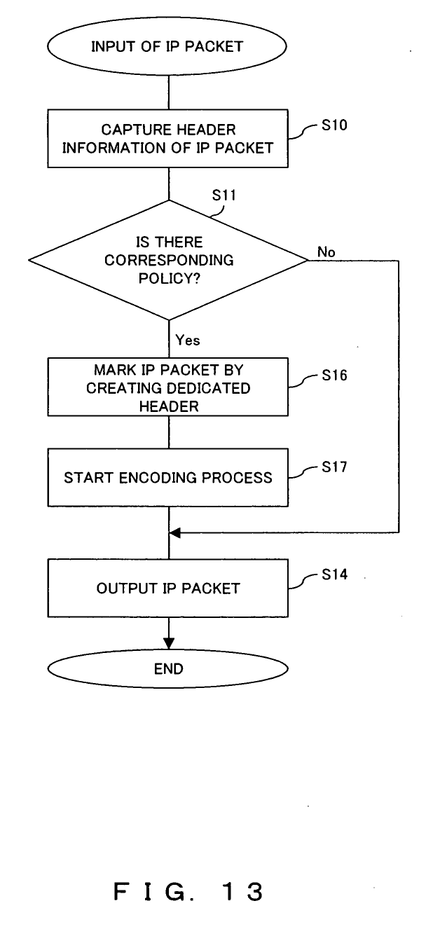

FIG. 13 is a detailed flowchart of the marking process which uses a dedicated header, corresponding to FIG. 8. Contrary to FIG. 12, when the policy for the service exists in step S11, the dedicated header is created in step S16 when the encoding process is needed for an application corresponding to the packet and marking is conducted on the dedicated header i.e. on the security header, thereafter, the encoding process is started in step S17. When the policy for the service does not exist, the IP packet is immediately output in step S14. In addition, also when the policy for the application does not exit in step S11, the encoding process is started when the encoding process is needed for the service corresponding to the input IP packet.

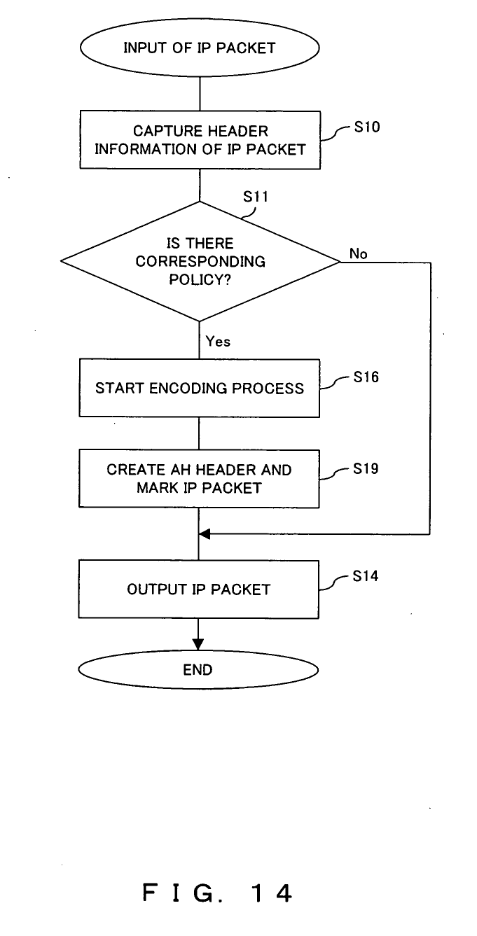

FIG. 14 is a detailed flowchart of the marking process conducted on AH header in IPsec communication. In FIG. 14, when the policy for the application corresponding to the IP packet exists in step S11, the encoding process is started in step S16 similarly as in FIG. 13 so that the AH header is created in step S19 and the marking is conducted on the reserved bits in the header, thereafter, the IP packet is output in step S14.

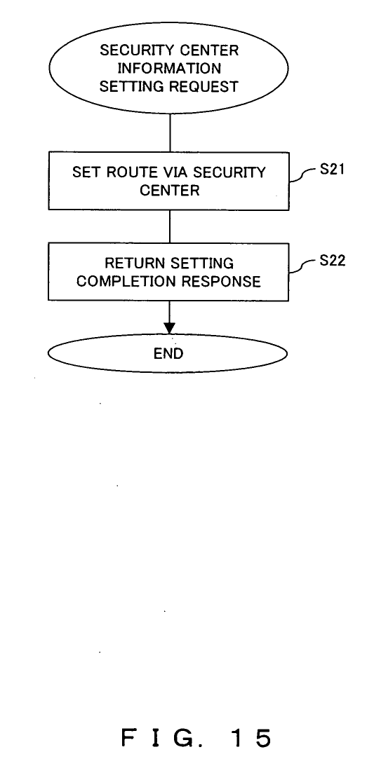

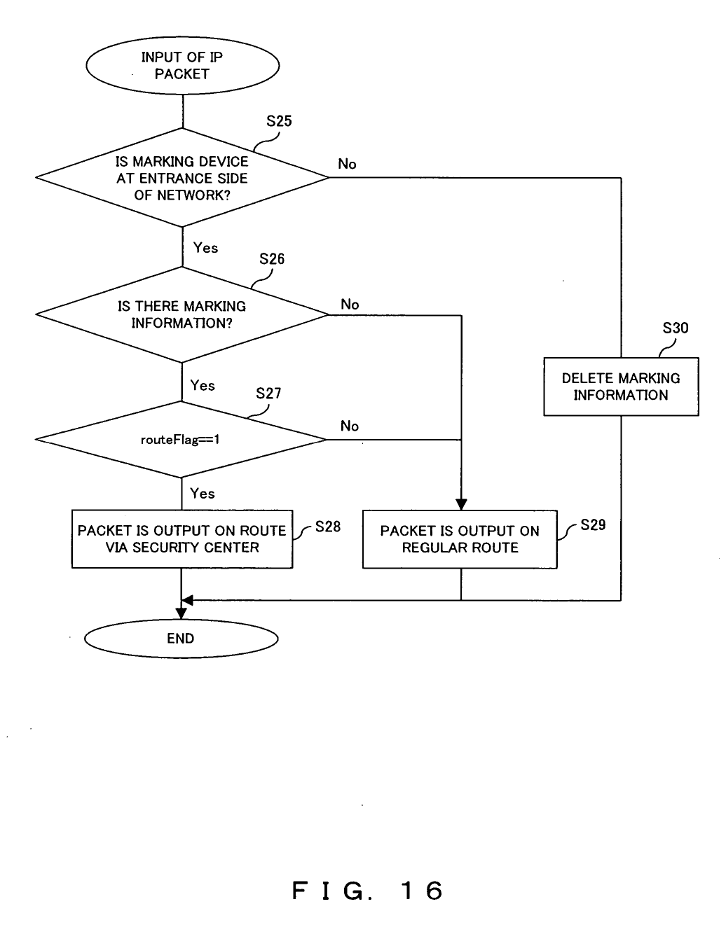

FIG. 15 and FIG. 16 are flowcharts of processes by the route selecting device 31 in FIG. 9. FIG. 15 is a flowchart of a process for responding to security center information setting request which is transmitted from the managing device 32, corresponding to a security policy. In accordance with this request, firstly a route via the security center is set i.e. the route information is stored in a security center information storing unit 38 in step S21, and the setting completion response is returned to the managing device 32 side so that the process is ended.

FIG. 16 is a detailed flowchart of a process conducted on an IP packet input from the marking device 30 side at the entrance of network or from the network side at the exit of the network. When the IP packet is input, it is determined whether or not the device itself is at the entrance side of the network in step S25. When the device is at the entrance side, it is determined whether or not marking information exists in header of the packet in step S26 and when the marking information exists, it is determined whether or not the route flag is “1” in step S27, and when the route flag is “1”, the packet is output on the route via the security center in step S28 and the process is ended.

When the marking device is not at the entrance side of the network in step S25, marking information is deleted in step S30 so that the process is ended. Also, when marking information does not exist in step S26 or when the route flag is not “1” in step S27, the packet is output on a regular route i.e. a direct communication route not via the security center so that the process is ended.

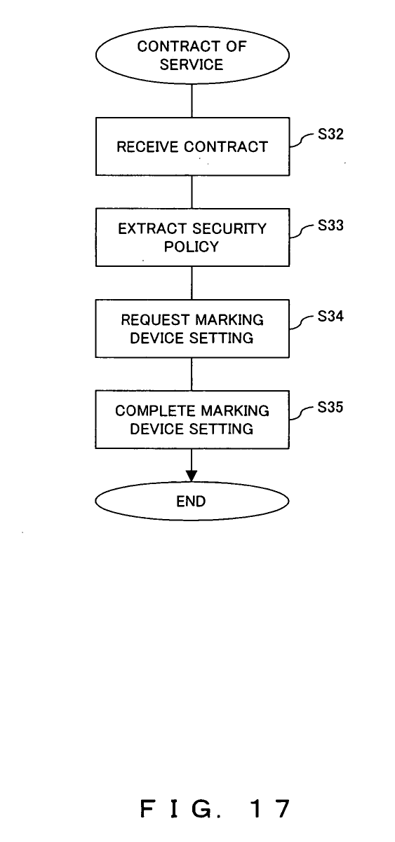

FIG. 17 is a flowchart of a process by the managing device 32 of FIG. 9. Here, a process which is conducted upon a contract of a service provided by, for example, an internet service provider (ISP), and is a setting process, in the marking device 30 of marking information corresponding to the contract is explained. Route information specifying the route via a security center via which the packet naturally has to be transmitted, corresponding to the service is set by the managing device 32. It is assumed that the above setting is conducted on the route selecting device 31 beforehand prior to the application for subscription of the service by a user, and the explanation of the process is omitted here.

In FIG. 17, a contract is received in response to an application for contract of service in step S32 and a security policy corresponding to the contract i.e. marking information is extracted in step S33. In step S34, the marking information setting request for the marking device 30 is output in step S34, thereafter, the setting completion response is received from the marking device 30 in step S35 so that the process is ended. By conducting marking in accordance with the security policy at a start time of communication corresponding to the contract, the time for control of network can be reduced.

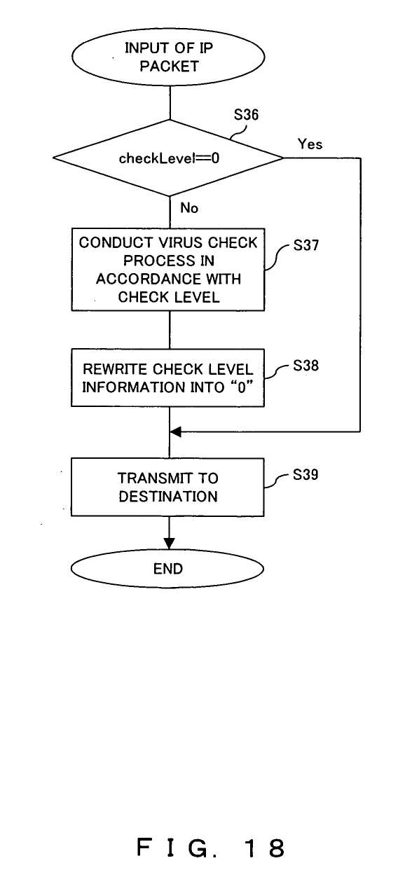

FIG. 18 is a flowchart of a process by the virus checking device. In FIG. 18, when an IP packet is input, it is determined whether or not a value of the check level is “0” in step S36. When the value is not “0”, a virus check process is conducted in accordance with the check level in step S37, and when the result of the virus check is “OK”, the value of the check level is rewritten into “0” as previously described in step S38, thereafter, the IP packet is transmitted to the transmission destination in step S39 so that the process is ended. When the value of the check level is “0”, the IP packet is transmitted to the transmission destination in step S39 without conducting any process.

As explained in FIG. 3, the marking of the route flag and the check level on the packet are conducted by the home gateway 17 as the marking device in the network of the user 10 side (local area network) or by a terminal 16 of the user and the packet is transmitted to the security gateway 18 as the route selecting device. In the above configuration it is advantageous that the marking function is realized by a dedicated LSI or the like on a communication route between the marking device 30 and the route selecting device 31, and at the same time, the marking information is conveyed to the route selecting device 31 in an encoded state because the marking information can be manipulated in the network of the user 10 side.

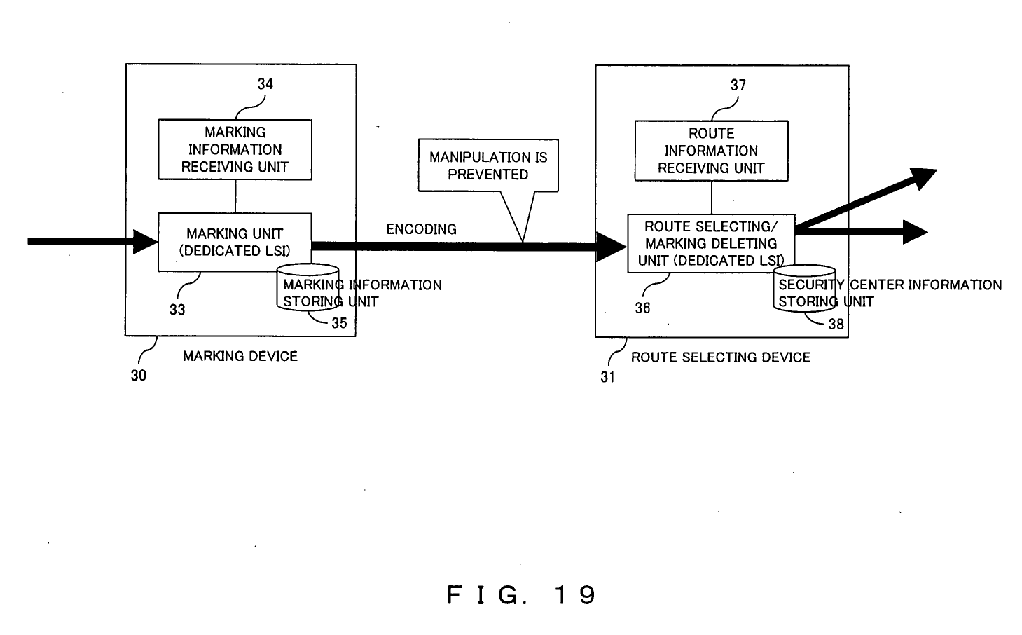

FIG. 19 explains the conveyance of the encoded marking information as above. In FIG. 19, the marking unit 33 is constituted of the dedicated LSI and the marking information is conveyed to the route selecting device 31 in an encoded state. Also the route selecting/marking deleting unit of the selecting device 31 side is constituted of the dedicated LSI. By realizing the marking by the dedicated LSIs as above, the setting of a check level to a level that is too high such as the case where a user always sets the security check level to “3” as the highest check level without permission can be prevented even in case that the terminal 16 of the user also has the function of the marking device. Alternatively, it is also possible that the encoding can be dispensed with by arranging the marking device 30 at the entrance side of the network 12 of a carrier in order to prevent the manipulation of the marking information.

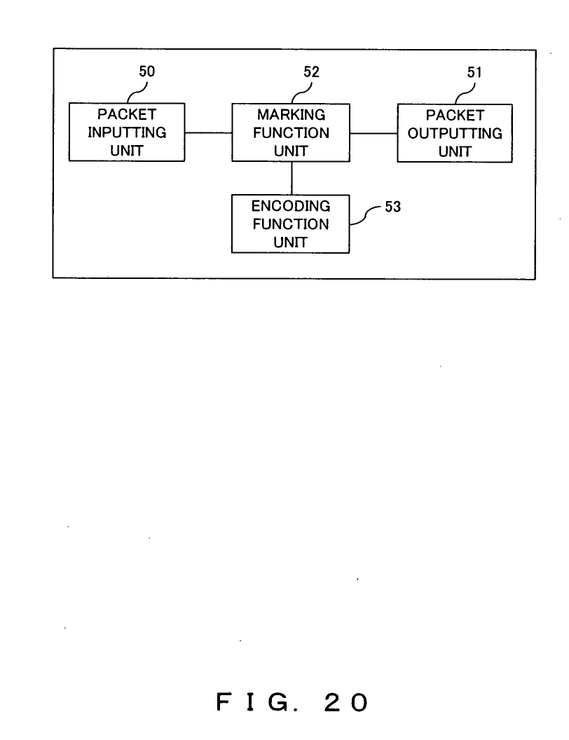

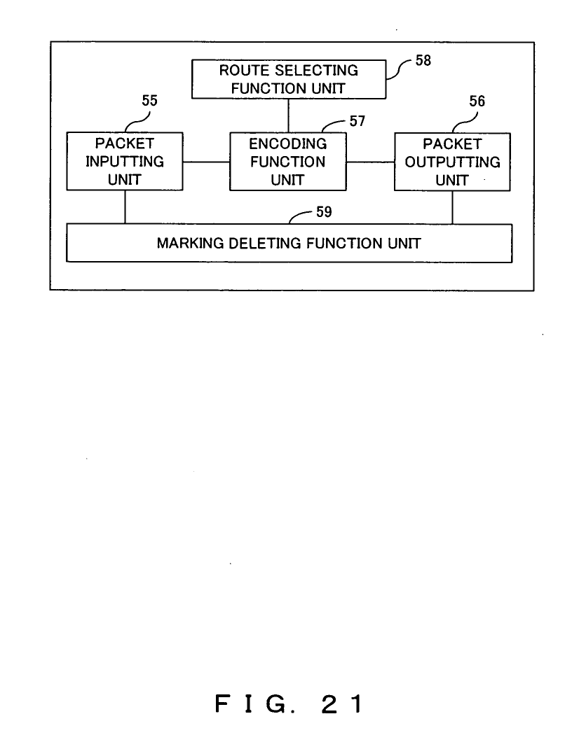

FIG. 20 and FIG. 21 are block diagrams of examples of the dedicated LSIs for the marking and the route selection described as above. FIG. 20 shows a configuration of the dedicated LSI for marking. This dedicated LSI comprises a packet inputting unit 50 for receiving a packet from, for example, a terminal of a user, a packet outputting unit 51 for outputting the packet to the route selecting device 31 side, a marking function unit 52 for conducting marking and an encoding function unit 53 for encoding marking information. Also, the packet received by the packet inputting unit 50 from the network 12 side of a carrier, is output from the packet outputting unit 51 to, for example, the terminal 16 of a user side via only the marking function unit 52.

FIG. 21 is a configuration block diagram of the dedicated LSI for the route selection. In FIG. 21, this LSI comprises a packet inputting unit 55 for receiving a packet from the marking device 30 side, an encoding function unit 57 for decoding encoded marking information, a route selecting function unit 58 for selecting a route in accordance with marking information, a packet outputting unit 56 for outputting the packet to, for example, the network 12 of a carrier, as well as a marking deleting function unit 59 for deleting the marking information in the packet before the packet received by the packet inputting unit 55 from the network 12 of a carrier is output from the packet outputting unit 56 to, for example, the terminal 16 of a user side.

What is claimed is:

1. A communication system for realizing a secure communication, comprising:
a communication route selecting device for making a selection between a communication route for a direct communication with a communication partner side and a communication route via a security checking device for checking security of communication, in accordance with a communication partner and/or an application corresponding to the communication.

2. The communication system for realizing a secure communication according to claim 1, wherein:
the communication system is a packet communication system;
the communication system further comprises a marking device for marking a communication packet for a route selection, in accordance with a communication partner and/or an application corresponding to the communication; and
the route selecting device conducts the route selection in accordance with contents of the marking.

3. The communication system for realizing a secure communication according to claim 2, wherein:
the marking device further adds level information specifying security check level as data of the marking to a communication packet; and
the security checking device conducts a security check of the specified level.

4. The communication system for realizing a secure communication according to claim 3, wherein:
when a plurality of the security checking devices exist on the communication route selected by the route selecting device, a security checking device which firstly receives, from a transmitting side of communication data, a communication packet to which the level information is added conducts a security check and rewrites the level information into a value specifying that a security check is not needed in order to output the packet on the selected communication route.

5. The communication system for realizing a secure communication according to claim 2, wherein:
the marking device stores the marking information in header information of a communication packet.

6. The communication system for realizing a secure communication according to claim 5, wherein:
the marking device sets data of the marking in a field of type of service in header information of IP packet as the communication packet.

7. The communication system for realizing a secure communication according to claim 5, wherein:
the marking device sets data of the marking in a storage area of reserved bits in authentication header of communication packet in an IP security protocol communication as a method of the packet communication.

8. The communication system for realizing a secure communication according to claim 5, wherein:
the marking device sets data of the marking in a dedicated header storage area by creating the dedicated header in a storage area originally for communication data in IP packet as the communication packet.

9. The communication system for realizing a secure communication according to claim 2, wherein:
a user terminal also has a function of the marking device.

10. The communication system for realizing a secure communication according to claim 9, wherein:
the route selecting device is arranged at an entrance of the network in which the route selection is conducted; and
the user terminal further comprises an encoding unit for encoding the marking information.

11. The communication system for realizing a secure communication according to claim 2, wherein:
the marking device is arranged in a network other than the network in which the route selection is conducted and also to which a user terminal in a packet transmitting side is connected.

12. The communication system for realizing a secure communication according to claim 11, wherein:
the route selecting device is arranged at an entrance of the network in which the route selection is conducted; and
the marking device further comprises an encoding unit for encoding the marking information.

13. The communication system for realizing a secure communication according to claim 2, wherein:
the marking device is arranged at an entrance of the network in which the route selection is conducted.

14. The communication system for realizing a secure communication according to claim 2, wherein:
the marking device further comprises a policy rule storing unit for storing a policy rule for marking which is received from a service provider upon a contract between the service provider and the transmitting side of the packet regarding an application corresponding to the communication in order that the marking is conducted at a time of starting communication corresponding to the application in accordance with the policy rule.

15. The communication system for realizing a secure communication according to claim 2, wherein:
when the transmitting side of the communication communicates with the communication partner side via an intermediary, the user terminal which also has a function of the marking device receives a policy rule for marking from the intermediary in order to mark the packet.

16. The communication system for realizing a secure communication according to claim 2, wherein:
the marking device conducts the marking, together with setting of header information in Diff-Serv which is a technique for the quality of service control for IP packet as the communication packet.

17. The communication system for realizing a secure communication according to claim 1, wherein:
the security checking device is arranged in a router of the network in which the route selection is conducted.

18. The communication system for realizing a secure communication according to claim 1, wherein:
the security checking device is arranged in a network other than the network in which the route selection is conducted; and
the communication route via the security checking device is constituted of a route from the transmitting side to the security checking device and a route from the checking device to a communication partner side.

19. A communication route selecting device for making a selection of a communication route to a communication partner side, wherein:
the communication route selecting device makes a selection between a communication route for a direct communication with a communication partner side and a communication route via a device for checking security of communication in accordance with a communication partner and/or an application corresponding to the communication.

20. The communication route selecting device according to claim 19, wherein:
a method of the communication is a packet communication; and
the communication route selecting device conducts the communication route selection in accordance with information including header information and a port number of the transmitting side in a transmission packet.
